(19) United States
(12) Patent Application Publication
(10) Pub. No.: US 2004/0136685 A1
(43) Pub. Date: Jul. 15, 2004

(54) Recording device and moving picture recording device with camera

(75) Inventors: Masataka Ota, Yokohama (JP); Hajime Akutsu, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 10/626,416

(22) Filed: Jul. 23, 2003

(30) Foreign Application Priority Data
Nov. 29, 2002 (JP) 2002-346776

(51) Int. Cl. H04N 5/76; H04N 5/225

(52) U.S. Cl. 386/46; 386/125

(57) ABSTRACT

The present invention provides a moving picture recording device which includes a buffer for temporarily storing video data to allow the photography time to be extended after recording in the recording medium has been terminated. In one embodiment, a moving picture recording camera comprises an imaging module configured to capture images and convert the images into an electrical signal; a video processing module configured to process the electrical signal and convert the electrical signal into a video signal; a recording module configured to record the video signal on a recording medium; a recording start instruction module configured to command a start of recording; a recording extension instruction module configured to command an extension of recording; a control module configured to control the recording module to record only for a first preset time period when the recording start instruction module is operated; and a temporary storage unit configured to temporarily store the video signal after a lapse of the first preset time period. The control module is configured to control the recording module to record on the recording medium the video signal which is stored in the temporary storage unit when the recording extension instruction module is operated after the lapse of the first preset time period.

### CROSS-REFERENCES TO RELATED APPLICATIONS

This application relates to and claims priority from Japanese Patent Application Number 2002-346776, filed on Nov. 29, 2002, the entire disclosure of which is incorporated herein by reference.

### BACKGROUND OF THE INVENTION

1. Field of the Invention

The present invention relates to a moving picture recording device which is fitted with a camera and can perform snap moving picture photography in such a way that photography is started when a photography start switch is operated and the photography is automatically ended when a predetermined photography time has elapsed.

2. Description of the Related Art

A technique of related art in the present technical field is disclosed in Reference 1 (JP-A-7-15693). This technique is intended to “reduce the degree of redundancy of photography”, and is configured to have a “short shooting mode of 5 seconds or so. The elapsed time of photography is counted down and displayed within the finder.” It has the advantage that “the short shooting mode of about 5 seconds can reduce the degree of redundancy and eliminate post-photographic editing.”

Furthermore, Reference 2 (JP-A-2000-69428) is intended to permit one to “extend the recording time at will simply by operating a recording button when separate moving picture sequences are recorded in given recording times and to provide a display that facilitates recognizing the state of operation during the moving recording.” The approach of this technique is constructed as follows. “An image signal picked up is processed by a camera signal processing portion for 5 seconds since depression of the shutter in the operation input portion. The digital image signal from the signal processing portion is compressed by MPEG by an encoder/decoder. The compressed image data is written into a DRAM under control of a memory controller. If the shutter is depressed before the elapse of 5 seconds, an appointment for extension of recording is made. The subject and the appointment for the extension are displayed on the LCD panel. If the finger is released from the shutter before the elapse of 5 seconds, normal recording operation is displayed. If the shutter is depressed when 5 seconds have passed, the recording extension is continued until the finger is released from the shutter. “During recording extension” is displayed.

In recent years, many small-sized, camera-fitted devices capable of recording moving pictures have been developed in succession. Existing video cameras such as 8-mm video cameras and digital video cameras for moving picture photography have been further miniaturized. In addition, such small-sized devices have found wider application including digital still cameras capable of recording moving pictures and cell phones with camera capable of recording moving pictures.

Under these backgrounds, camera-fitted devices which have small storage capacities and can record moving pictures have increased in number. A method of limiting the moving picture photography time in one shot sequence has been proposed as in the above-described related art. This photography method is hereinafter referred to as “snap moving picture photography mode.” According to Reference 1, the contents can be understood sufficiently even if the photography is done in the snap moving picture photography mode for about 5 seconds, the degree of redundancy of photography is suppressed, and the recording capacity can be saved. Furthermore, normal photography, i.e., photography for an arbitrary time, is permitted according to the method of depressing the photography start switch. This is hereinafter referred to as “normal photography mode.” In particular, if the photography start switch is depressed in a short time, snap moving picture photography is performed. If the start switch is kept depressed for more than 5 seconds, photography is continued during the depression.

According to Reference 2, the recording time can be extended by starting photography in the snap moving picture photography mode and depressing the photography start switch again before a snap moving picture sequence is completely taken. According to Reference 2, if the photography start switch is depressed in a short time during snap moving picture photography, then a 5-second appointment for an extension is made. If the start switch is kept depressed past the snap moving picture photography end time, arbitrary extension is permitted until the finger is released.

However, in any of the above-described techniques of related art, the user must decide whether to extend the snap moving picture photography time within this photography time. Where the user wants to take a scene immediately after the end of snap moving picture photography, it is necessary to perform snap moving picture photography by depressing the photography start switch again. Accordingly, images from the end of snap moving picture photography to restart of photography will be missed. Therefore, there is the problem that important scenes might be missed.

Where the user wants to extend the snap photography time, this can be implemented by depressing the photography start switch before the end of photography and keeping depressing it until a desired photography stop time. In this case, however, there is a problem that the photography start switch must be kept depressed throughout the extension time. If the finger inadvertently releases from the switch during the extension, the photography will be stopped.

### SUMMARY OF THE INVENTION

To solve the foregoing problems, a camera-fitted device having a snap moving picture photography mode is preferably so designed that the photography time can be extended even after the end of snap moving picture photography. This is desirable because convenience in use is improved. Furthermore, in order to solve the foregoing problems, when the user wants to extend the snap photography time, if it is unnecessary to keep depressing the photography start switch, convenience in use is improved with desirable results. It is a feature of the present invention to improve convenience in use in snap moving picture photography by solving the foregoing problems.

In accordance with an aspect of the present invention, a moving picture recording camera comprises an imaging module configured to capture images and convert the images into an electrical signal; a video processing module configured to process the electrical signal and convert the electrical signal into a video signal; a recording module configured to record the video signal on a recording medium; a recording start instruction module configured to command a start of recording; a recording extension instruction module configured to command an extension of recording; a control module configured to control the recording module to record only for a first preset time period when the recording start instruction module is operated; and a temporary storage unit configured to temporarily store the video signal after a lapse of the first preset time period. The control module is configured to control the recording module to record on the recording medium the video signal which is stored in the temporary storage unit when the recording extension instruction module is operated after the lapse of the first preset time period.

In accordance with another aspect of the invention, a moving picture recording camera comprises an imaging module configured to capture images and convert the images into an electrical signal; a video processing module configured to process the electrical signal and convert the electrical signal into a video signal; a recording module configured to record the video signal on a recording medium; a recording start-and-stop instruction module configured to command start and stop of recording; and a photography mode selection module configured to select between a normal photography mode in which recording is made from the instant when a recording start command is given by the recording start-and-stop instruction module to the instant when a recording end command is given by the recording start-and-stop instruction module, and a snap moving picture photography mode in which recording is made for a preset time period after a photography start command is given by the recording start-and-stop instruction module. When the video signal is being recorded in one of the two photography modes, if the photography mode selection module is operated, photography mode is switched to the other photography mode and recording is made in the other photography mode.

In accordance with another aspect of the invention, a recording device comprises an input module into which an information signal is entered; a temporary storage unit configured to temporarily store the information signal; a recording module configured to record the information signal on a recording medium; a recording stop instruction module configured to command a stop of recording by the recording module; a recording extension instruction module configured to command an extension of recording by the recording module; and a control module configured, when the recording stop instruction module is operated, to cause the recording module to stop the recording and temporarily store in the temporary storage unit the information signal after the stop of recording and, when the recording extension instruction module is operated after the stop of recording, to cause the recording module to record on the recording medium the information signal stored in the temporary storage unit after the stop of recording.

In accordance with yet another aspect of the invention, a method for recording comprises, upon receiving a recording start instruction for recording an information signal, starting recording the information signal on a recording medium; upon stopping recording on the recording medium, temporarily storing the information signal from a time of stopping the recording; and upon receiving a recording extension instruction, recording on the recording medium the temporarily stored information signal from the time of stopping the recording.

### BRIEF DESCRIPTION OF THE DRAWINGS

FIG. 1 is a block diagram of a moving picture recording device with camera, showing a first embodiment of the present invention;

FIG. 2 is a timing chart illustrating the manner in which a snap moving picture photography time can be extended even after the end of snap moving picture photography in the first embodiment;

FIG. 3 is a block diagram of a moving picture recording device with camera, showing a second embodiment of the invention;

FIG. 4 is a flowchart illustrating the flow from start to end of photography in the second embodiment of the invention;

FIG. 5 is a simplified view of a screen display showing an extension acceptable time;

FIG. 6 is a simplified view of a screen display showing a buffer check selection; and

FIG. 7 is a simplified view of a screen display showing a record time-setting operation.

### DESCRIPTION OF THE PREFERRED EMBODIMENTS

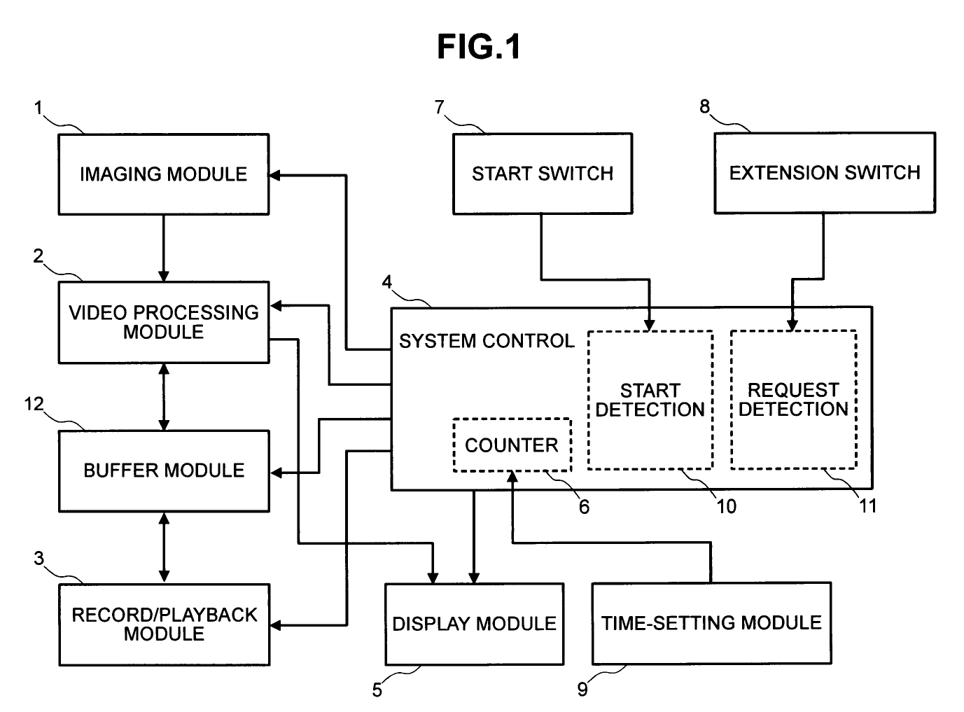

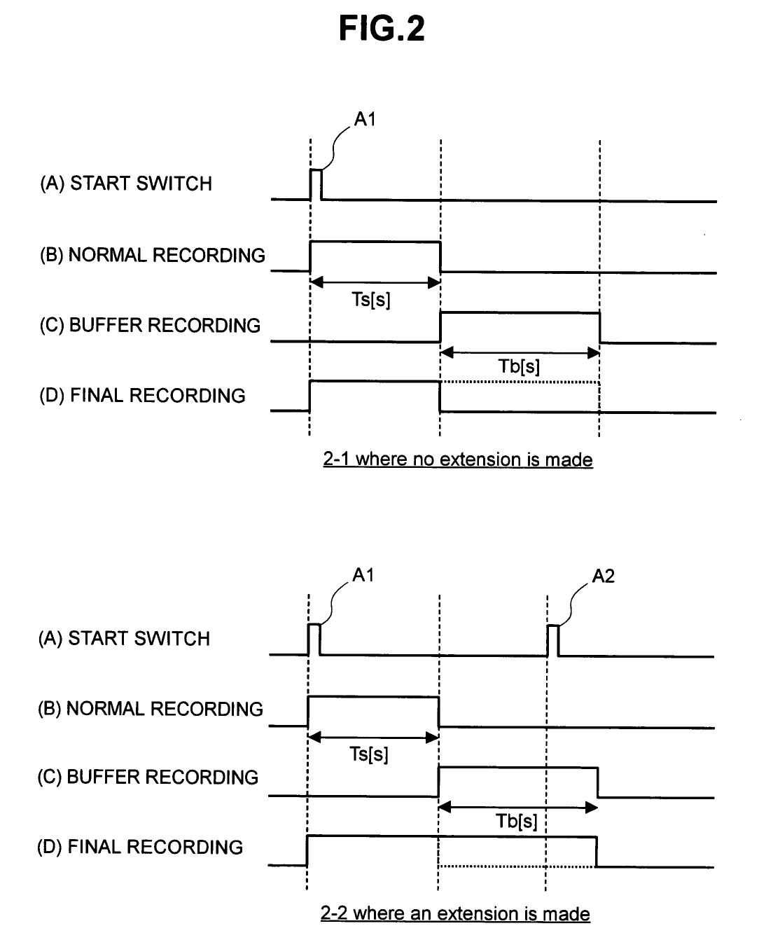

A first embodiment of the present invention is hereinafter described by referring to the block diagram of FIG. 1 and the timing chart of FIG. 2.

FIG. 1 is a block diagram showing a moving picture recording device with camera capable of extending the photography time even after the end of snap moving picture photography, the recording device being the first embodiment of the invention. The device has an imaging module 1 typically including a lens, a CCD sensor, and an A/D converter. This imaging module converts a taken image (optical signal) into an electrical signal under control of system control module 4. The electrical signal is converted into a video signal adapted for record/playback module 3 or display module 5 in video processing module 2 controlled by the system control module 4. Where the taken image is displayed on the display module 5 that is implemented by a liquid crystal display, for example, the signal is converted into a video signal in a format corresponding to the size or number of pixels of the liquid crystal display. The record/playback module 3 typically includes a hard disk drive (HDD) or optical disk drive, and records the video signal converted by the video processing module 2 or plays back a previously recorded video signal and sends it to the video processing module 2. In the present invention, the record/playback module is not limited to a disk recorder. It may also be a tape recorder or IC memory recorder, for instance.

The system control module 4 has a counter 6 therein. In this counter 6, a snap moving picture photography time specified by the user using snap moving picture photography time-setting module 9 is held in a memory (not shown). It is assumed, for example, that the value of the counter 6 is varied in increments of 1/1000 second and that the snap moving picture photography time is set to 10 seconds by the user. After the power supply has been turned on, the initial value of the counter 6 is set to 0. Value “10000” is held in a memory for snap moving picture photography time. At the instant when the user depresses a photography start switch 7 and a trigger signal is entered into a photography start detection portion 10 within the system control module 4, the value of the counter 6 is set to the above-described value “110000” (=10 seconds) held in the memory for snap moving picture photography. Subsequently, the value of the counter 6 is decremented. Just when 10 seconds have passed, the value reaches 0. The end of the snap photography occurs after a time elapse of Ts [s] for normal recording. The system control module 4 controls the moving picture recording device with camera in such a way that photography is continued until the value of the counter 6 is decremented to 0. In this way, snap moving picture photography is accomplished. That is, the photography is automatically ended after 10 seconds since the start switch 7 was depressed by the user.

To extend the snap moving picture photography, an extension request detection portion 11 and a snap moving picture photography extension switch 8 are provided within the system control module 4. When the user wants an extension of snap moving picture photography, the extension time can be set at will using the photography time-setting module 9. This is realized by providing a memory (not shown) for extension of snap moving picture photography, as well as the above-described memory for the snap moving picture photography time. As an example, if the user sets the extension time of snap moving picture photography to 5 seconds, value “5000” is held in the memory for extension time of snap moving picture photography. If the user starts photography in the snap moving picture photography mode, and if the snap moving picture photography extension switch 8 is depressed when 8 seconds have passed, a trigger signal is entered into the extension request detection portion 11 within the system control module 4. At this instant, the value of the counter 6 is set to value “5000” held in the memory for extension time of snap moving picture photography. The counter 6 decrements with the elapse of time and the value reaches 0 after a lapse of 5 seconds, whereupon the photography ends. As a result, a snap moving picture sequence can be taken for 8 seconds+5 seconds=13 seconds in this case. In the description of the present embodiment, when the snap moving picture photography extension switch 8 is depressed, the value “5000” held in the memory for extension of the snap moving picture photography is set. This value may also be directly added to the present counter's value. In this case, if the extension switch 8 is depressed when 8 seconds have passed after the start of snap moving picture photography, the value of the counter 6 becomes equal to value “2000” assumed after a lapse of eight seconds+“5000”=“7000.” The photography is further continued for 7 seconds. In total, a snap moving picture sequence is taken for 15 seconds. This extension of snap moving picture photography may be limited to once. Further extension may be permitted by depressing the snap moving picture photography extension switch 8 again during the extended photography. Of course, as in the techniques of related art, snap moving picture recording may be extended while the snap moving picture extension switch is kept depressed. Thus, the camera can record images that may be important and would otherwise be missed if no further extension is possible. The memory for setting snap moving picture photography time and the memory for setting extension time of snap moving picture photography are provided. Alternatively, only one memory may be provided, and snap moving picture photography time and snap moving picture photography extension time may be made identical. The total memory required can be smaller and the circuit for accessing the memory is simpler.

In the present invention, buffer module 12 is disposed between the video processing module 2 and the record/playback module 3. The buffer module 12 temporarily stores the signal from the video processing module 2 as long as the buffer capacity permits. Because of the provision of this buffer module 12, snap moving picture photography can be extended even after the end of this snap photography. This is described by referring to the timing chart of FIG. 2.

FIGS. 2-1 shows the manner in which snap moving picture photography is not extended. In waveform (A), the high level indicates that the switch is ON, while low level indicates that the switch is OFF. When the photography start switch 7 is depressed (A1), pictures are recorded in a HDD or optical disk drive for time Ts [s] set by the snap moving picture photography time-setting module 9. On the other hand, after a lapse of Ts [s] since the photography start switch 7 was depressed, recording in the buffer 12 is started. The time Tb [s] for which a recording is made in the buffer 12 is an extension operation acceptable time after the end of snap moving picture photography. Where any operation for extension is not performed within this extension operation acceptable time, the recording in the buffer 12 is abandoned. Only data corresponding to the time Ts [s] since depression of the photography start switch 7 is recorded.

In the above description, if any operation for extension is not performed within the extension operation acceptable time, the recording in the buffer 12 is abandoned. The recording may not be abandoned immediately. For example, the recording in the buffer 12 may be held until the next recording is started or the power supply is turned off. In this case, pictures recorded in the buffer 12 are made capable of being played back until the recording in the buffer 12 is abandoned. For example, a buffer check switch (not shown) may be provided. Operation on this buffer check button may be detected by the system control module 4. Signal recorded in the buffer module 12 may be read out and converted in a given manner by the video processing module 2. The resulting signal may be displayed on the display module 5. The user may check pictures recorded in the buffer 12 after the end of snap moving picture photography. If the user judges that pictures corresponding to the recording in the buffer 12 are necessary, the user operates the snap moving picture photography extension switch 8. Then, the pictures recorded in the buffer 12 are sent to the record/playback module 3, which records them on a recording medium. In this way, the user can check the recording in the buffer 12. If necessary, the user can make recordings. The snap moving picture photography extension switch 8 may also act as the buffer check button. If the user activates the single switch/button during extension operation acceptable time, the switch is recognized as the extension switch. If the user activates the single switch/button outside the extension operation acceptable time, the switch is recognized as a buffer check button. This provides the benefits of cost savings and convenience of use by operating a single switch in different situations to activate different functions.

FIGS. 2-2 shows the manner in which the snap moving picture photography extension switch 8 is depressed (A2) before the time Th [s] elapses since the end of snap moving picture photography to request an extension. The manner in which data corresponding to time Ts+Th [s] subsequent to depression of the photography start switch is recorded is illustrated.

In FIGS. 2-2, the final recording is made for the time Ts+Tb [s]. It is to be noted that the extension time is not limited to Th [s]. For instance, data obtained until there is a request for extension (A2) may be finally recorded. That is, the extension time is from Ts to the instant when the request for extension (A2) is made, thereby avoiding unnecessary photography beyond the instant (A2). Extension of a time exceeding the Tb [s] may be accomplished by making a recording in a HDD or optical disk drive while storing data in the buffer module. In the above description of the present embodiment, recording is made in the buffer after recording is made in the HDD or optical disk drive for the time Ts [s] after depression of the photography start switch. Obviously, it is also possible that the system control module 4 appropriately records the signal from the video processing module 2 in the record/playback module 3 while storing the signal in the buffer module 12 such that the buffer capacity is not exceeded.

In the description provided so far, the structure has two switches, i.e., the photography start switch 7 and the snap moving picture photography extension switch 8. It is also possible that the snap moving picture photography start switch 7 performs the functions of the extension switch 8 as well as its own functions. In this case, the trigger signal from the photography start switch 7 is entered also into the extension request detection portion 11. With respect to the trigger signal from the photography start switch 7, priority is given to the photography start detection portion 10 except for during photography. During photography, priority is given to the extension request detection portion 11. In this way, only one switch is necessary. Therefore, cost increase can be circumvented. There is the advantage that the user can easily extend the photography time with one switch.

Where the photography start switch 7 acts also as the moving picture photography extension switch 8, operations performed when the user wants to take a snap moving picture sequence are problematic. To avoid this, the following approach can be adopted.

For example, in the case of start of snap moving picture photography, the photography start switch 7 is pushed once. In the case of extension of the snap moving picture photography, the start switch 7 is depressed twice. By using the switch in different ways or different situations, two kinds of requests can be discriminated with one button even during recording in the buffer after the end of the snap moving picture photography. Since start is made more frequently than extension, single-push operation may be used for start and double-push operation may be used for extension.

For example, where snap moving picture photography is started, the photography start switch 7 is pushed for a short time. Where snap moving picture photography is extended, photography start switch 7 is pushed for a longer time. Also, in this case, two kinds of requests can be distinguished with one switch. In this case, when the result of the decision is that there is a request for extension after depressing the button for a longer time, information notifying the user that the request for an extension has been accepted may be displayed on the viewing screen. For example, if an on-screen display (OSD) menu indicating that the “extension is OKed” is displayed on the display module 5, the user can understand easily.

Furthermore, there is a method of permitting the user to make a decision in advance as to whether snap moving picture photography is extended. In particular, a snap moving picture photography extension mode ON/OFF switch (not shown) is mounted. Using this switch, the user makes a decision in advance as to whether an extension is to be made. Where extension ON is selected and the photography start switch 7 is operated during recording in the buffer, extension is permitted at all times. Where the extension OFF is selected and the start switch 7 is operated during recording in the buffer, a new snap moving picture sequence is always started to be recorded. Of course, the snap moving picture photography extension ON/OFF switch may be realized by software. A menu may be displayed on the display module to permit the user to make a choice.

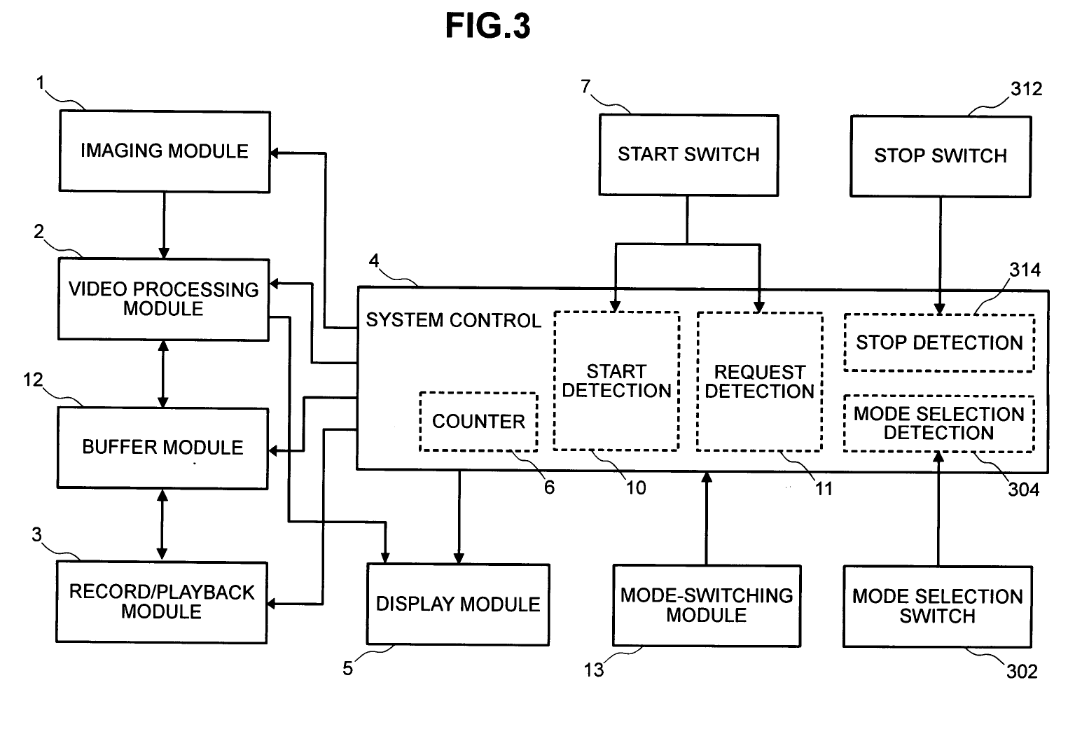

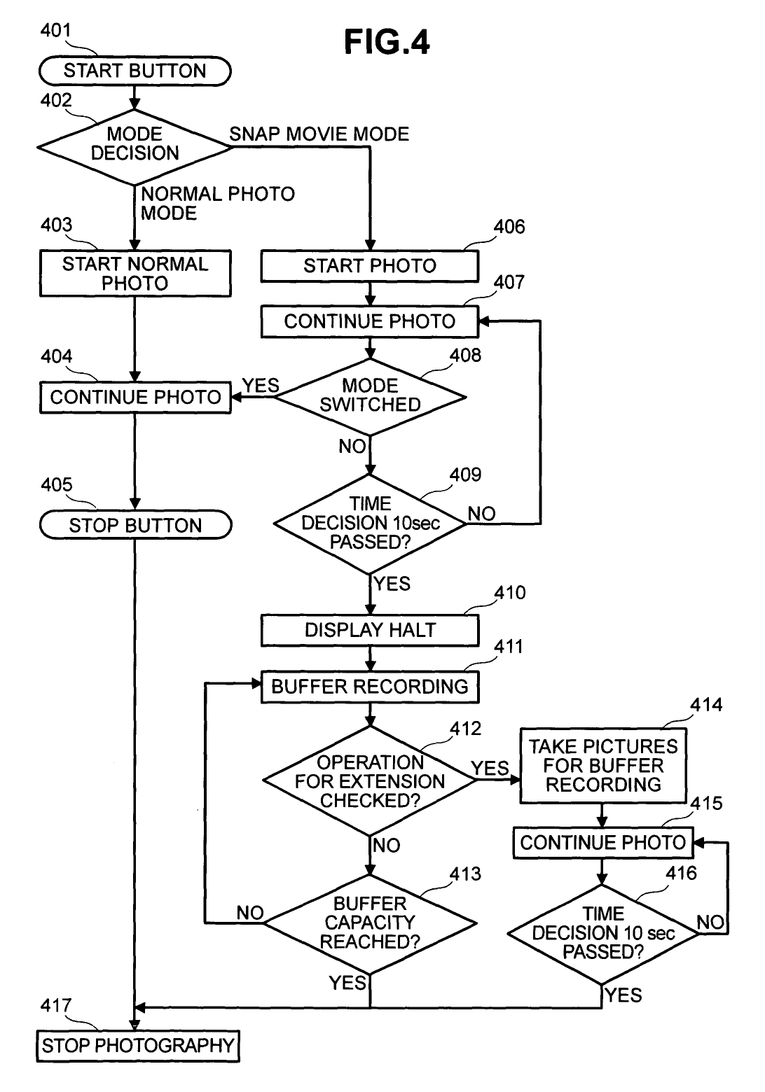

A moving picture recording device with camera is described as a second embodiment of the present invention by referring to the block diagram of FIG. 3 and the flowchart of FIG. 4. This moving picture recording device has a mechanism capable of selecting between snap moving picture photography mode and normal photography mode. During photography in the snap moving picture photography mode, the mode can be switched to normal photography. The difference of FIG. 3 with FIG. 1 is that there is provided photography mode-switching module 13. This switching module 13 may be accomplished by hardware such as a slide switch or by software, and the present photography mode may be displayed on the display module 5.

The flow from start to end of photography in the second embodiment is described by referring to the flowchart of FIG. 4. It is assumed that the power supply of the moving picture recording device with camera has been turned on and the user has selected a photography mode in a manner not illustrated in the flowchart of FIG. 4.

The photography mode is selected as follows. In one available method, this selection is made using a photography selection switch 302, for example (see FIG. 3). In this case, the output from the photography mode selection switch 302 is detected by a photography mode detection module 304 provided in the system control module 4, and a decision is made as to whether the mode is normal photography mode or snap moving picture photography mode. When the video signal is being recorded in one of the two photography modes, if the photography mode selection module 302 is operated, the photography mode is switched to the other photography mode and recording is made in the other photography mode. For example, when the photography start switch 7 is depressed during snap moving picture photography, extension of the snap moving picture photography is detected. The photography mode is switched by moving the photography mode selection switch 302 from the snap moving picture photography mode side to the normal photography mode side.

In the specific embodiment shown in FIG. 3, a stop switch 312 can be activated to stop the recording, and the output of the stop switch 312 is detected by the stop detection module 314 provided in the system control 4. In another embodiment, a start-and-stop instruction module or switch may replace the start switch 7 and the stop switch 312 by issuing a start command or a stop command, and a start-and-stop detection module may replace the start detection module 10 and the stop detection module 314. In that case, the recording start-and-stop switch will command start and stop of recording. The system control module 4 is configured, when the recording start-and-stop switch is operated, to control the recording module 3 to record in a corresponding manner to the photography mode selected by the photography mode selection module 302 and which, when the photography mode-switching module 13 is operated during photography in the snap moving picture photography mode, controls the recording module 3 to record in a corresponding manner to the normal photography mode.

In another available method, a flag indicating a photography mode is contained in the system control module 4. The photography mode is selected in software. More specifically, in a case, the user can select a photography mode in advance from option settings in a menu. A command such as “Photography Mode: Normal/Snap” is prepared. Either mode is selected. The selected mode is set. That is, this selection corresponds to rewriting the value of the flag indicating the photography mode into the internal memory of the system control module 4. If there is a request to switch the mode during snap moving picture photography, the flag's value is rewritten by internal software processing, thus switching the mode. In this case, if the user sees the option setting next, it follows that normal mode is selected. In the description provided so far, a mode is selected with an option setting. Alternatively, as in the above-described method, a photography mode selection switch may be mounted. The photography mode may be varied whenever the button is pushed once. The information may be displayed as an on-screen display (OSD) menu on the display module.

When the photography start switch 7 is pushed (401), a mode decision is made (402). If normal photography mode is selected, normal photography is started (403). The photography is continued intact (404). When the user pushes the photography stop button 312 (405), the photography is stopped (417). In the present embodiment, it is assumed that the photography start switch 7 acts also as the photography stop button. Where the result of the decision (402) is that snap moving picture photography mode is selected, snap moving picture photography is started (406). The photography is continued (407) until 10 seconds pass since depression of the photography start switch 7. In this embodiment, if the start switch 7 is pushed during snap moving picture photography (407), the system control module 4 judges that there is a request to switch the mode (408). The mode is switched to normal photography mode, and photography is continued (404). In this way, the mode can be easily switched to normal recording mode simply by pushing the photography start switch 7 again during snap moving picture photography. Where the mode has been switched to normal recording mode, the photography can be stopped (417) by pushing the photography start switch 7 at arbitrary timing (405). Thus, the time can be extended where the user feels that the shooting time is insufficient during snap moving picture photography.

On the other hand, where 10 seconds have passed while there is no request to switch the mode to normal photography mode (409), a display indicating that the photography is halted is provided on the display module 5 (410). Recording of photographs in the record/playback module 3 is halted. At the same time, recording in the buffer module 10 is started (411). In the present embodiment, operation for extension of snap moving picture photography can be accepted (412) until the buffer capacity is reached (413). In the present embodiment, operation for extension of snap moving picture photography is also assigned to the photography start switch 7. For example, if the buffer capacity corresponds to 5 seconds, the photography is stopped (417) when 5 seconds have passed since the end of snap moving picture photography, i.e., the start of recording in the buffer. On the other hand, if the photography start switch 7 is pushed during recording in the buffer and an operation requesting an extension is confirmed (412), the data stored in the buffer module 10 is recorded in the record/playback module 3 (414). The photography is continued (415) until 10 seconds pass since the start of recording in the buffer. The photography is stopped when 10 seconds have passed (417).

In this way, a snap moving picture sequence 20 seconds long is taken. Therefore, the snap moving picture photography can be extended without break even after snap moving picture photography. Of course, no break occurs between these two snap moving picture sequences and so there is the advantage that the user will not miss out on any good photographic opportunity. Of course, a snap moving picture sequence corresponding to first 10 seconds and a snap moving picture sequence corresponding to 10 seconds after the start of recording in the buffer may be separately recorded. In the present embodiment, the photography start switch 7 is used for all various operations, i.e., to start photography, end photography, switch the mode during snap moving picture photography, and perform an operation for extension during recording in the buffer. Of course, separate switches may be provided for these operations.

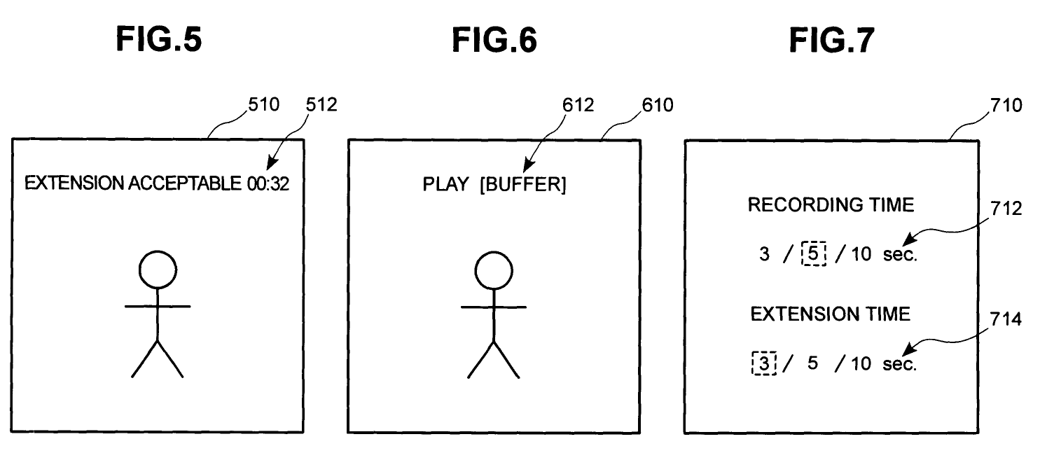

FIGS. 5-7 illustrate several screen displays that may be provided as output to the user. In FIG. 5, the screen 510 shows the extension acceptable time remaining 512 to the user during the time Tb[s] when the user may utilize the extension operation to record the video signal temporarily stored in the buffer 12. FIG. 6 shows playback of the recording in the buffer 12 on the screen 610 when the buffer check switch is pressed. The buffer indication 612 lets the user know that the images being displayed are stored in the buffer 12. In FIG. 7, the screen 510 displays the recording time (Ts[s]) 512 and extension time (Tb[s]) 514 which can be set by the user.

The present invention offers improved convenience in the operation of snap moving picture photography. In all the embodiments described so far, the present invention is effective regardless of the storage capacity.

Furthermore, in all the embodiments described so far, the case in which operations are performed using plural switches and the case in which one switch acts as plural switches have been described. It is to be noted that the relations between switches and the functions assigned to the switches are not limited to the relations described in the embodiments. In particular, the functions may be assigned variously to the switches to realize the functions of the invention described so far. Every assignment is embraced within the scope of the invention. For example, the photography start switch and the snap moving picture photography extension switch may be made of two separate switches or a single switch may be used for both purposes. Furthermore, the photography mode selection module and the photography mode switching module may be made of two separate switches or a single switch may act as these two switches. When a single switch is used in different situations to activate different functions, it provides cost savings and convenience of use. In addition, in the embodiments described so far, cases where switches are used have been principally described. The invention is not limited to this. These structures may be implemented by software performing similar functions. In this case, a menu window, for example, is displayed on the display module. The user selects a desired function from this menu window. In this way, operations are performed.

In all the embodiments described so far, a moving picture recording device with camera is taken as an example. The invention can also be applied to other recording devices. For example, it can be a recording device fitted with input module for entering video signal from the outside. The video signal may contain still pictures as well as moving pictures. In addition, audio signals may be included. That is, the signal may be every kind of information signal containing moving pictures, still pictures, and speech.

In the description of all the embodiments provided so far, where the user wants to extend the photography time, a video signal obtained until recording stops and another video signal recorded for an extension time are spliced and recorded. Other methods making use of the invention are also conceivable. For example, in the above description, a video signal obtained after stop of recording is stored in the buffer module and the storing operation is stopped when the capacity of the buffer module is reached. Alternatively, after the capacity is reached, the video signal may be made to overwrite the first recording in the buffer module. Subsequently, this overwriting may be repeated to store the newest video signal corresponding to the capacity of the buffer at all times. Where an extension of the photography time is commanded during a given time, this recording in the buffer is recorded on a recording medium. Subsequently, the video signal is started to be recorded from the instant when an extension is commanded. In this case, the video signal occurring until the recording is stopped is discontinuous with the video signal recorded for an extension time. However, there is an advantage that if there is a good photographic opportunity after the end of recording, the user will not miss the opportunity by giving an instruction for an extension.

The above-described arrangements of apparatus and methods are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

What is claimed is:

1. A moving picture recording camera comprising:
an imaging module configured to capture images and convert the images into an electrical signal;
a video processing module configured to process the electrical signal and convert the electrical signal into a video signal;
a recording module configured to record the video signal on a recording medium;
a recording start instruction module configured to command a start of recording;
a recording extension instruction module configured to command an extension of recording;
a control module configured to control the recording module to record only for a first preset time period when the recording start instruction module is operated; and
a temporary storage unit configured to temporarily store the video signal after a lapse of the first preset time period;
wherein the control module is configured to control the recording module to record on the recording medium the video signal which is stored in the temporary storage unit when the recording extension instruction module is operated after the lapse of the first preset time period.

2. A moving picture recording camera as set forth in claim 1, wherein, when the recording extension instruction module is operated after the lapse of the first preset time period, the control module is configured to control the recording module to record on the recording medium the video signal which is stored in the temporary storage unit so as to follow the video signal recorded on the recording medium during the first preset time period.

3. A moving picture recording camera as set forth in claim 1, wherein the recording start instruction module and the recording extension instruction module are operated by using a single button in different situations.

4. A moving picture recording camera as set forth in claim 1, wherein the temporary storage unit is configured to temporarily store the video signal produced after the lapse of the first preset time period for a second preset time period, and wherein the control module is configured to control the recording module to record on the recording medium, when the recording extension instruction module is operated during the second preset time period, the video signal stored in the temporary storage unit during the second preset time period.

5. A moving picture recording camera as set forth in claim 4, further comprising a recording time-setting module configured to setting at least one of the first and second preset time periods.

6. A moving picture recording camera as set forth in claim 1, wherein the temporary storage unit is configured to temporarily store the video signal produced after the lapse of the first preset time period for a second preset time period, and wherein the control module is configured to control the recording module to record on the recording medium, when the recording extension instruction module is operated during the second preset time period, the video signal stored in the temporary storage unit from a beginning of the second preset time period to an instant when the recording extension instruction module is operated.

7. A moving picture recording camera as set forth in claim 1, further comprising a buffer check switch which is actuatable to cause playback of the video signal stored in the temporary storage unit.

8. A moving picture recording camera as set forth in claim 7, wherein the buffer check switch is actuatable to cause playback of the video signal stored in the temporary storage unit until recording in the temporary storage unit is terminated.

9. A moving picture recording camera as set forth in claim 7, further comprising a recording extension switch which is actuatable to operate the recording extension instruction module; wherein the recording extension switch and the buffer check switch are operated by using a single button in different situations.

10. A moving picture recording camera comprising:
an imaging module configured to capture images and convert the images into an electrical signal;
a video processing module configured to process the electrical signal and convert the electrical signal into a video signal;
a recording module configured to record the video signal on a recording medium;
a recording start-and-stop instruction module configured to command start and stop of recording; and
a photography mode selection module configured to select between a normal photography mode in which recording is made from the instant when a recording start command is given by the recording start-and-stop instruction module to the instant when a recording end command is given by the recording start-and-stop instruction module, and a snap moving picture photography mode in which recording is made for a preset time period after a photography start command is given by the recording start-and-stop instruction module;
wherein when the video signal is being recorded in one of the two photography modes, if the photography mode selection module is operated, photography mode is switched to the other photography mode and recording is made in the other photography mode.

11. A moving picture recording camera as set forth in claim 10, further comprising:
a photography mode-switching module configured to switch photography mode to the normal photography mode during photography in the snap moving picture photography mode; and
a control module which is configured, when the recording start-and-stop instruction module is operated, to control the recording module to record in a corresponding manner to the photography mode selected by the photography mode selection module and which, when the photography mode-switching module is operated during photography in the snap moving picture photography mode, controls the recording module to record in a corresponding manner to the normal photography mode.

12. A moving picture recording camera as set forth in claim 11, further comprising a temporary storage unit configured to temporarily store the video signal after a lapse of the preset time period in the snap moving picture photography mode; and a recording extension instruction module configured to command an extension of recording,
wherein the control module is configured to control the recording module to record on the recording medium the video signal stored in the temporary storage unit after the lapse of the preset time period when the recording extension instruction module is operated.

13. A moving picture recording camera as set forth in claim 11, wherein the recording start-and-stop instruction module and the photography mode-switching module are operated by using a single button in different situations.

14. A recording device comprising:
an input module into which an information signal is entered;
a temporary storage unit configured to temporarily store the information signal;
a recording module configured to record the information signal on a recording medium;
a recording stop instruction module configured to command a stop of recording by the recording module;
a recording extension instruction module configured to command an extension of recording by the recording module; and
a control module configured, when the recording stop instruction module is operated, to cause the recording module to stop the recording and temporarily store in the temporary storage unit the information signal after the stop of recording and, when the recording extension instruction module is operated after the stop of recording, to cause the recording module to record on the recording medium the information signal stored in the temporary storage unit after the stop of recording.

15. A recording device as set forth in claim 14, wherein the temporary storage unit is configured to temporarily store the information signal for a preset time period after the stop of recording, and wherein the control module is configured to control the recording module to record on the recording medium, when the recording extension instruction module is operated during the preset time period after the stop of recording, the information signal stored in the temporary storage unit during the preset time period after the stop of recording.

16. A recording device as set forth in claim 14, wherein the temporary storage unit is configured to temporarily store the information signal for a preset time period after the stop of recording, and wherein the control module is configured to control the recording module to record on the recording medium, when the recording extension instruction module is operated during the preset time period after the stop of recording, the information signal stored in the temporary storage unit from a beginning of the preset time period to an instant at which the recording extension instruction module is operated.

17. A recording device as set forth in claim 14, further comprising a buffer check switch which is actuatable to cause playback of the information signal stored in the temporary storage unit.

18. A method for recording, comprising:
upon receiving a recording start instruction for recording an information signal, starting recording the information signal on a recording medium;
upon stopping recording on the recording medium, temporarily storing the information signal from a time of stopping the recording; and
upon receiving a recording extension instruction, recording on the recording medium the temporarily stored information signal from the time of stopping the recording.

19. A method as set forth in claim 18 wherein the temporarily stored information signal is temporarily stored from the time of stopping the recording for a preset time period, and wherein upon receiving the recording extension instruction, the temporarily stored information signal for the preset time period is recorded on the recording medium.

20. A method as set forth in claim 18 wherein the temporarily stored information signal is temporarily stored from the time of stopping the recording for a preset time period, and wherein upon receiving the recording extension instruction during the preset time period, the temporarily stored information signal is recorded on the recording medium from the time of stopping the recording to the time of receiving the recording extension instruction.
